(19) United States
(12) Patent Application Publication
(10) Pub. No.: US 2026/0244233 A1
(43) Pub. Date: Aug. 20, 2026

(54) LOW DROPOUT VOLTAGE REGULATOR

(71) Applicant: LX Semicon Co.,Ltd., Daejeon (KR)

(72) Inventors: JEONG RIM HONG, Daejeon (KR); JANG HYUN YOON, Daejeon (KR); TAE WOO KIM, Daejeon (KR)

(73) Assignee: LX Semicon Co.,Ltd., Daejeon (KR)

(21) Appl. No.: 19/538,913

(22) Filed: Feb. 12, 2026

(30) Foreign Application Priority Data
Feb. 18, 2025 (KR) 10-2025-0020678

(51) Int. Cl. G05F 1/575; G05F 1/565

(52) U.S. Cl. CPC G05F 1/575; G05F 1/565

(57) ABSTRACT

A low dropout voltage regulator according to one aspect of the present invention with improved transient response performance includes a flipped voltage follower (FVF) circuit including a control transistor configured to regulate an output voltage at an output node and a pass transistor configured to supply a load current to the output node, a cascode transistor connected to the control transistor to reduce output impedance of the FVF circuit, an amplifier configured to amplify a difference between a feedback voltage generated based on the output voltage and a reference voltage and output the amplified difference to the control transistor, and a first capacitor configured to separate a first pole formed at a gate terminal of the pass transistor from a second pole formed at the output node in a frequency band.

### CROSS-REFERENCE TO RELATED APPLICATIONS

This application claims the benefit of the Korean Patent Application No. 10-2025-0020678 filed on February 18, 2025, which is hereby incorporated by reference as if fully set forth herein.

### BACKGROUND

### Field of the Invention

The present disclosure relates to a voltage regulator, and more particularly, to a low dropout voltage regulator.

### Discussion of the Related Art

A voltage regulator is configured to continuously maintain a level of an output voltage at a target level. Voltage regulators are widely used in electronic devices that require a constant voltage. For example, when the current consumption of a load increases, a level of an output voltage may tend to decrease. In this case, a voltage regulator may maintain a level of an output voltage at a target level by increasing an amount of an output current.

As another example, when the current consumption of a load decreases, a level of an output voltage may tend to increase. In this case, a voltage regulator may maintain a level of an output voltage at a target level by reducing an amount of an output current.

A low dropout (LDO) voltage regulator, which is one type of voltage regulator, is used to drive circuits that are sensitive to a supply voltage. An LDO voltage regulator may remove a ripple in a supply voltage or provide a constant voltage even when a load current instantaneously and significantly changes. A typical LDO voltage regulator includes an error amplifier, a power transistor, and an external capacitor and forms negative feedback. LDO voltage regulators have an advantage of a simple structure but have a disadvantage in that an area and costs increase due to an external capacitor.

Accordingly, the use of capacitor-less type LDO voltage regulators that do not use external capacitors has recently been increasing. Capacitor-less type LDO voltage regulators may provide an accurate output voltage with only small ripple, low costs, and a simple structure, and thus may be used in various semiconductor circuits such as Internet of Things (IoT) and system-on-chip (SoC) applications.

However, capacitor-less type LDO voltage regulators have a disadvantage in that an output voltage changes instantaneously and significantly, resulting in low transient response performance.

### SUMMARY

The present disclosure is directed to providing a low dropout voltage regulator with improved transient response performance.

The present disclosure is also directed to providing a low dropout voltage regulator capable of increasing a gain margin by improving loop stability.

The present disclosure is also directed to providing a low dropout voltage regulator capable of increasing a phase margin by improving loop stability.

According to an aspect of the present disclosure, there is provided a low dropout voltage regulator including a flipped voltage follower (FVF) circuit including a control transistor configured to regulate an output voltage at an output node and a pass transistor configured to supply a load current to the output node, a cascode transistor connected to the control transistor to reduce output impedance of the FVF circuit, an amplifier configured to amplify a difference between a feedback voltage generated based on the output voltage and a reference voltage and output the amplified difference to the control transistor, and a first capacitor configured to separate a first pole formed at a gate terminal of the pass transistor from a second pole formed at the output node in a frequency band.

According to another aspect of the present disclosure, there is provided a low dropout voltage regulator including a first transistor connected between a voltage supply line and an output node from which an output voltage is output, a second transistor connected between the output node and a ground node, a third transistor connected to a drain terminal of the second transistor, a fourth transistor connected to a drain terminal of the third transistor and the gate terminal of the first transistor, an amplifier configured to amplify a difference between a feedback voltage generated based on the output voltage and a reference voltage and output the amplified difference to a gate terminal of the second transistor; and a first capacitor connected to a gate terminal of the first transistor and a drain terminal of the second transistor to separate a first pole formed at the gate terminal of the first transistor from a second pole formed at the output node in a frequency band through Miller compensation.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a schematic block diagram illustrating a configuration of a low dropout voltage regulator according to an embodiment of the present disclosure;

FIG. 2 is a circuit diagram illustrating an embodiment of the low dropout voltage regulator shown in FIG. 1;

FIG. 3 shows Bode plots showing positions of poles in a frequency band when no first capacitor is added to the low dropout voltage regulator;

FIG. 4 shows Bode plots showing positions of a first pole and a third pole in a frequency band and a gain margin and a phase margin according to the positions when the first capacitor is added to the low dropout voltage regulator;

FIG. 5 shows Bode plots showing positions of a first pole and a third pole and a position of a zero in a frequency band and a gain margin and a phase margin according to the positions when a second capacitor is added to the low dropout voltage regulator; and

FIG. 6 is a block diagram of an electronic device including the low dropout voltage regulator shown in FIG. 1.

### DETAILED DESCRIPTION OF THE DISCLOSURE

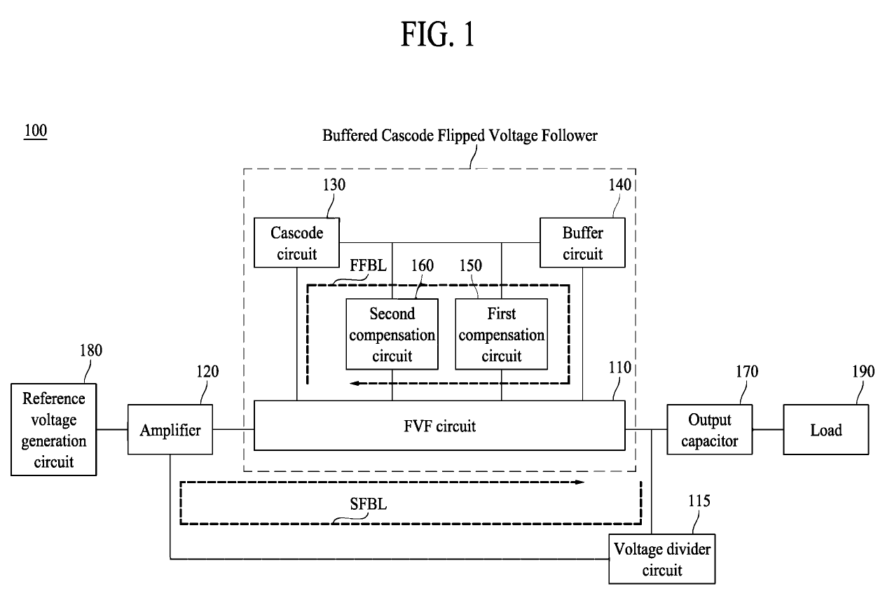

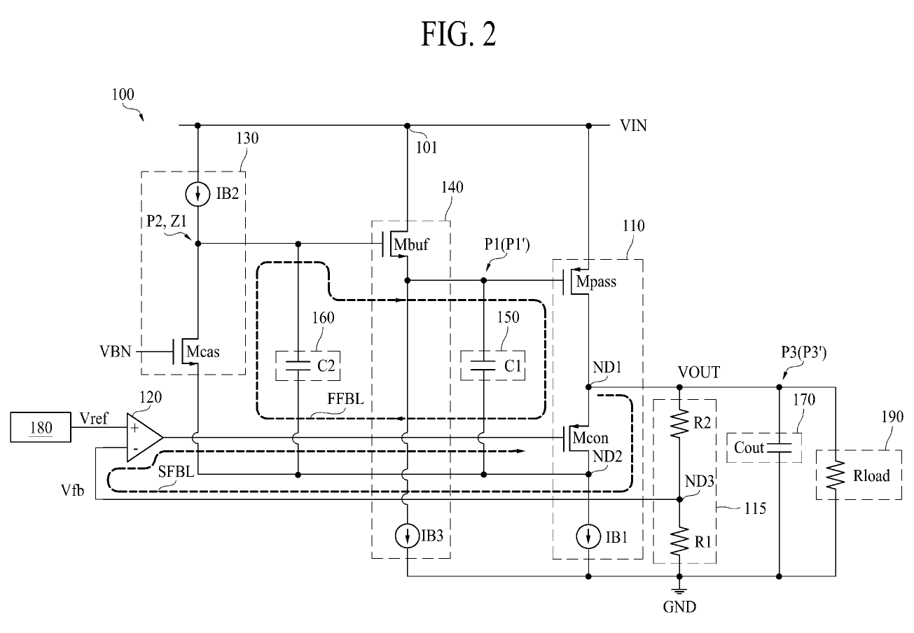

FIG. 1 is a schematic block diagram illustrating a configuration of a low dropout (LDO) voltage regulator according to one embodiment of the present disclosure. FIG. 2 is a circuit diagram illustrating an embodiment of the LDO voltage regulator shown in FIG. 1.

An LDO voltage regulator 100 shown in FIGS. 1 and 2 may be a capacitor-less type LDO voltage regulator that does not include a separate external capacitor. Unlike a typical LDO voltage regulator that includes an external capacitor, the LDO voltage regulator 100 according to one embodiment of the present disclosure is a capacitor-less type that does not include a separate external capacitor, thereby simplifying a bill of materials (BOM).

As shown in FIGS. 1 and 2, the LDO voltage regulator 100 according to one embodiment of the present disclosure includes a flipped voltage follower (FVF, hereinafter referred to as “FVF”) circuit 110, a voltage divider circuit 115, an amplifier 120, a cascode circuit 130, a buffer circuit 140, a first compensation circuit 150, a second compensation circuit 160, an output capacitor 170, and a reference voltage generation circuit 180.

In FIGS. 1 and 2, the LDO voltage regulator 100 is illustrated as including the buffer circuit 140 and the second compensation circuit 160, but the buffer circuit 140 and the second compensation circuit 160 may be optionally included.

The FVF circuit 110 improves the transient response characteristics of the LDO voltage regulator 100. The LDO voltage regulator 100 according to one embodiment of the present disclosure includes the FVF circuit 110, thereby providing a high-performance voltage regulation function using characteristics such as a fast response speed, low output impedance, and low-voltage operation. That is, the LDO voltage regulator 100 according to one embodiment of the present disclosure enables more efficient and stable voltage regulation as compared to a typical LDO voltage regulator.

In one embodiment, as shown in FIG. 2, the FVF circuit 110 includes a first transistor Mpass, a second transistor Mcon, and a first bias current source IB1.

The first transistor Mpass is connected between a voltage supply line 101 for supplying an operating voltage VIN and a first node ND1 (or an output node). That is, a source terminal of the first transistor Mpass is connected to the voltage supply line 101, and a drain terminal of the first transistor Mpass is connected to the first node ND1. The first transistor Mpass performs a function of a pass transistor that supplies a current (load current) according to an output voltage VOUT to a load 190 through the first node ND1. Therefore, the first transistor Mpass may be referred to as a pass transistor.

The operating voltage VIN may be maintained as the output voltage VOUT by a voltage dropout between the drain terminal and the source terminal of the first transistor Mpass.

The second transistor Mcon is connected between the first node ND1 and a second node ND2. That is, a source terminal of the second transistor Mcon is connected to the first node ND1, and a drain terminal of the second transistor Mcon is connected to the second node ND2. The second transistor Mcon performs a function of a common drain amplifier or source follower amplifier that controls the output voltage VOUT of the LDO voltage regulator 100 according to an output voltage of the amplifier 120 supplied to a gate terminal of the second transistor Mcon. Therefore, the second transistor Mcon may be referred to as a control transistor.

The first transistor Mpass and the second transistor Mcon may be implemented as first type transistors (for example, p-channel metal-oxide semiconductor (PMOS) transistors).

The first bias current source IB1 is connected between the second node ND2 and a ground GND to cause a first constant current to flow between the second node ND2 and the ground GND. Therefore, a voltage of the second node ND2 is determined by the output voltage VOUT and an impedance ratio of the second transistor Mcon and the first bias current source IB1.

The voltage divider circuit 115 divides the output voltage VOUT to generate a feedback voltage Vfb. The voltage divider circuit 115 outputs the feedback voltage Vfb to the amplifier 120. In one embodiment, as shown in FIG. 2, the voltage divider circuit 115 may include a first resistor R1 and a second resistor R2.

The first resistor R1 and the second resistor R2 perform a function of a voltage divider that divides the output voltage VOUT, and a voltage divided by the first resistor R1 and the second resistor R2 is supplied (or fed back) to the amplifier 120 as the feedback voltage Vfb.

Specifically, as shown in FIG. 2, the first resistor R1 and the second resistor R2 included in the voltage divider circuit 115 may be connected in series between the first node ND1 and the ground GND. The first resistor R1 is connected between a third node ND3 and the ground GND, a first terminal of the second resistor R2 is connected to the first node ND1, and a second terminal of the second resistor R2 is connected to the third node ND3.

The amplifier 120 also referred to as an error amplifier amplifies a difference between the feedback voltage Vfb generated based on the output voltage VOUT and a reference voltage Vref and outputs the amplified difference to a control transistor Mcon. In one embodiment, as shown in FIG. 2, the amplifier 120 includes a first input terminal for receiving the reference voltage Vref, a second input terminal connected to the third node ND3, and an output terminal connected to the gate terminal of the second transistor Mcon.

Although FIG. 2 illustrates that the first input terminal is a non-inverting input terminal and the second input terminal is an inverting input terminal, this is merely an example, and in other embodiments, the first input terminal may be an inverting input terminal, and the second input terminal may be a non-inverting input terminal.

The cascode circuit 130 is connected to the FVF circuit 110 to reduce output impedance of the FVF circuit 110. In one embodiment, as shown in FIG. 2, the cascode circuit 130 includes a third transistor Mcas and a second bias current source IB2.

As shown in FIG. 2, a drain terminal of the third transistor Mcas is connected to a gate terminal of a fourth transistor Mbuf included in the buffer circuit 140, and a source terminal of the third transistor Mcas is connected to a drain terminal of the control transistor Mcon through the second node ND2. A bias voltage VBN is input to a gate terminal of the third transistor Mcas. The third transistor Mcas operates according to the bias voltage VBN to reduce the output impedance of the FVF circuit 110. The third transistor Mcas may be referred to as a cascode transistor.

The second bias current source IB2 is connected between the voltage supply line 101 and the drain terminal of the third transistor Mcas to cause a second constant current to flow between the voltage supply line 101 and the drain terminal of the third transistor Mcas. Therefore, a voltage according to a constant current flowing in the second bias current source IB2 and a resistance value of the third transistor Mcas is generated at a node to which the drain terminal of the third transistor Mcas is connected.

The buffer circuit 140 is connected to the FVF circuit 110 to further reduce the output impedance of the FVF circuit 110. In one embodiment, as shown in FIG. 2, the buffer circuit 140 includes the fourth transistor Mbuf and a third bias current source IB3.

As shown in FIG. 2, the fourth transistor Mbuf is connected between the voltage supply line 101 and a gate terminal of the first transistor Mpass. The fourth transistor Mbuf may further reduce the output impedance of the FVF circuit 110 by being operated according to a voltage applied to the gate terminal of the fourth transistor Mbuf (a voltage according to a constant current flowing in the second bias current source IB2 and a resistance value of the third transistor Mcas). The fourth transistor Mbuf may be referred to as a buffer transistor.

The third bias current source IB3 is connected between a source terminal of the fourth transistor Mbuf and the ground GND to cause a third constant current to flow between the source terminal of the fourth transistor Mbuf and the ground GND. Therefore, a voltage of the source terminal of the fourth transistor Mbuf is determined by the feedback voltage Vfb according to a change in output voltage VOUT.

In the above-described embodiment, the third transistor Mcas and the fourth transistor Mbuf may be implemented as second type transistors ((for example, n-channel metal-oxide semiconductor (NMOS) transistors).

As shown in FIG. 1, the FVF circuit 110, the cascode circuit 130, and the buffer circuit 140 may constitute a buffered cascode FVF circuit.

Meanwhile, as shown in FIGS. 1 and 2, the LDO voltage regulator 100 according to one embodiment of the present disclosure may include two feedback loops FFBL and SFBL.

A main feedback loop SFBL is formed by the FVF circuit 110, the voltage divider circuit 115, and the amplifier 120. More specifically, the main feedback loop SFBL may be formed by the first node ND1, the second resistor R2, the amplifier 120, and the second transistor Mcon.

A sub-feedback loop FFBL may operate before the main feedback loop SFBL operates, thereby improving transient response characteristics. The sub-feedback loop FFBL is formed by the FVF circuit 110, the cascode circuit 130, and the buffer circuit 140. More specifically, the sub-feedback loop FFBL may be formed by the first node ND1, the first transistor Mpass, the second transistor Mcon, the third transistor Mcas, and the fourth transistor Mbuf.

The first compensation circuit 150 increases a gain margin and a phase margin by improving loop stability. Specifically, the first compensation circuit 150 separates (or splits) a first pole P1 formed at the gate terminal of the first transistor Mpass from a third pole P3 formed at the first node ND1 in a frequency band. In this case, the first pole P1 is one of poles of a transfer function of the sub-feedback loop FFBL.

In one embodiment, as shown in FIG. 2, the first compensation circuit 150 may be implemented as a first capacitor C1 for Miller compensation. That is, the first capacitor C1 is a capacitor added in the present disclosure to secure loop stability of the buffered cascode FVF circuit. According to this embodiment, as shown in FIG. 2, the first capacitor C1 is connected between the gate terminal of the first transistor Mpass and the second node ND2.

Miller compensation is a compensation technique used to secure frequency stability in a feedback loop or a feedback circuit. In Miller compensation, by using a Miller effect, a capacitor is added between specific nodes to adjust poles of a circuit.

In Miller compensation, as a gain increases, poles may be separated further from each other in a frequency band. In the LDO voltage regulator 100 according to the present disclosure, since the first transistor Mpass has a large size and thus has a large gain, the first capacitor C1 is connected between the gate terminal of the first transistor Mpass and the second node ND2 to further separate the first pole P1 and the third pole P3 from each other in a frequency band.

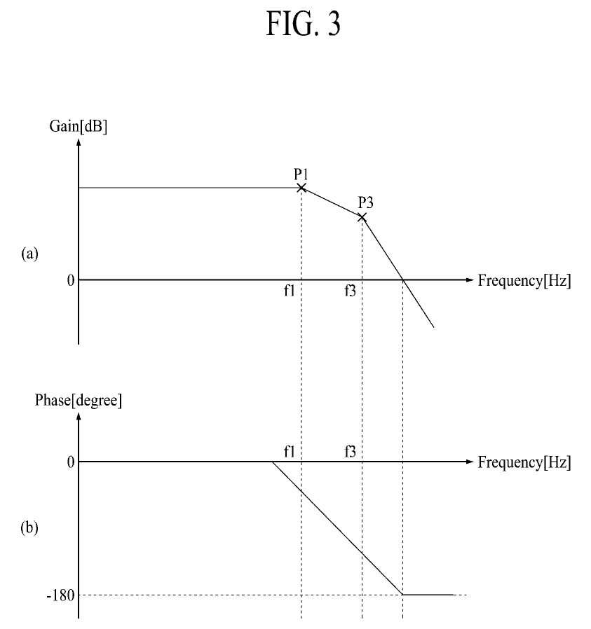

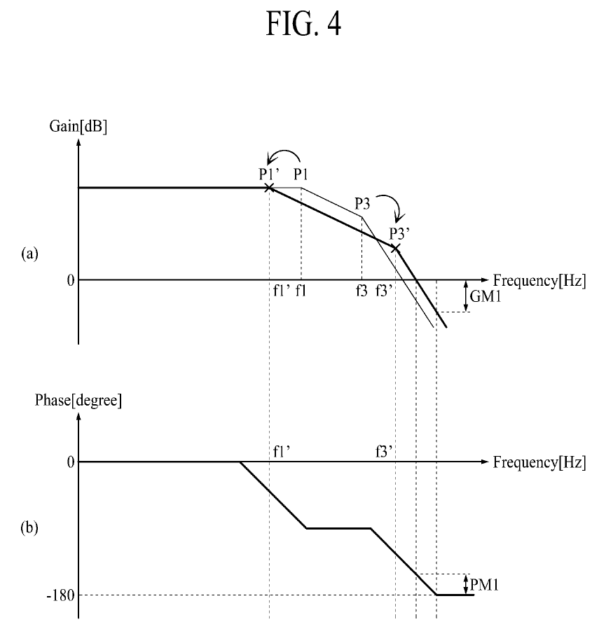

Hereinafter, the separation of first and second poles in a frequency band due to the first capacitor C1, and the improvement of a gain margin and a phase margin due to the separation will be described in more detail with reference to FIGS. 3 and 4.

FIG. 3 shows Bode plots showing positions of poles in a frequency band when no first capacitor is added.

Referring to FIG. 3, when there is no Miller compensation, since a first pole P1 formed at the gate terminal of the first transistor Mpass and a third pole formed at the first node ND1 (for example, a third pole P3 formed by an output capacitor Cout) are both located in a high-frequency region in a frequency band, and the first pole P1 and the third pole P3 are close to each other, it is difficult to secure a phase margin and a gain margin. In FIG. 3, a first frequency f1 is a frequency of the first pole P1, a third frequency f3 is a frequency of the third pole P3, and the third frequency f3 is higher than the first frequency f1.

FIG. 4 shows Bode plots showing positions of a first pole P1 and a third pole P3 in a frequency band and a gain margin and a phase margin according to the positions when the first capacitor C1 is added to the LDO voltage regulator 100 for Miller compensation.

Referring to FIG. 4, when the first capacitor C1 is added to the LDO voltage regulator 100, it can be seen that, in a frequency band, the first pole P1 shifts toward a low frequency due to Miller compensation, and the third pole P3 shifts toward a high frequency due to Miller compensation. In this case, a first frequency f1’ of a Miller-compensated first pole P1’ is lower than a first frequency f1 of the first pole P1, and a third frequency f3’ of a Miller-compensated third pole P3’ is higher than a third frequency f3 of the third pole P3.

That is, referring to FIGS. 3 and 4, the first pole P1 and the third pole P3 without Miller compensation using the first capacitor C1 shift to the Miller-compensated first pole P1’ and the Miller-compensated third pole P3’ due to Miller compensation using the first capacitor C1, and as a result, there is an effect in which the first pole P1 and the third pole P3 are separated from each other by the first capacitor C1. Therefore, both a gain margin GM1 and a phase margin PM1 increase.

The second compensation circuit 160 simultaneously increases a gain margin and a phase margin by further improving loop stability. Specifically, the second compensation circuit 160 adds a zero between a first pole formed at the gate terminal of the first transistor Mpass and a second pole formed at the first node ND1 in a frequency band.

In one embodiment, as shown in FIG. 2, the second compensation circuit 160 may be implemented as a second capacitor C2. As shown in FIG. 2, the second capacitor C2 is connected between the gate terminal of the fourth transistor Mbuf and the second node ND2.

In this way, since the second capacitor C2 is connected between the gate terminal of the fourth transistor Mbuf and the second node ND2, the second capacitor C2 may directly transmit a high-frequency signal from the drain terminal of the second transistor Mcon to the gate terminal of the fourth transistor Mbuf by bypassing the third transistor Mcas, thereby forming a zero in a frequency response.

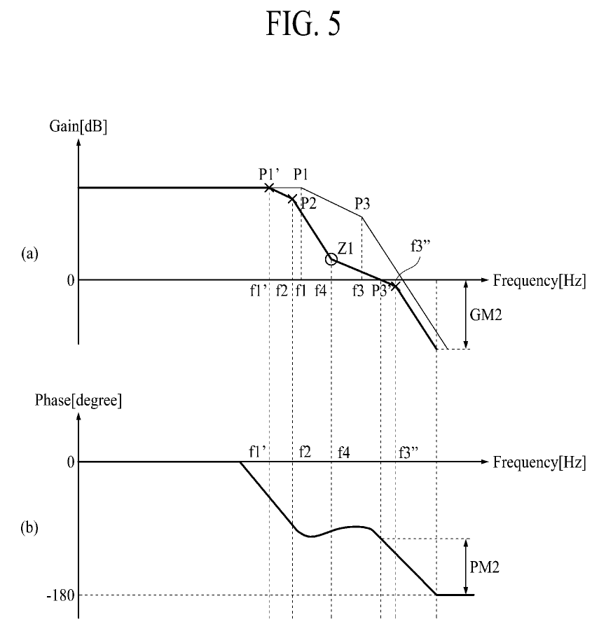

Hereinafter, the addition of a zero in a frequency band due to the second capacitor C2 and the further improvement of a gain margin and a phase margin due to the addition will be described in more detail with additional reference to FIG. 5.

FIG. 5 shows Bode plots showing positions of a first pole P1 and a third pole P3 and a position of a zero Z1 in a frequency band and a gain margin and a phase margin according to the positions when the second capacitor C2 is added to the LDO voltage regulator 100 to add the zero.

Referring to FIG. 5, the first pole P1 and the third pole P3 without Miller compensation shift to a first pole P1’ and a third pole P3’’ in a frequency band due to the addition of the first and second capacitors C1 and C2, and when the second capacitor C2 is added, the zero Z1 is added to a transfer function of the sub-feedback loop FFBL by a resistance value of the fourth transistor Mbuf and capacitance of the second capacitor C2. In this case, a second pole P2 is also added along with the zero Z1. A second frequency f2 of the second pole P2 is higher than a first frequency f1’ of the Miller-compensated first pole P1’ and lower than a fourth frequency f4 of the zero Z1. In addition, the fourth frequency f4 of the zero Z1 is higher than the second frequency f2 of the second pole P2 and lower than a third frequency f3’’ of the compensated third pole P3’’.

That is, referring to FIGS. 3 to 5, the first pole P1 and the third pole P3 without Miller compensation using the first capacitor C1 shift to the Miller-compensated first pole P1’ and the Miller-compensated third pole P3’ due to Miller compensation using the first capacitor C1, and a third pole P3` shifts to the third pole P3’’, which is a high-frequency point in a unit gain bandwidth or more, due to the addition of the zero Z1 through the second capacitor C2. Thus, it can be seen that both a gain margin GM2 and a phase margin PM2 additionally increase as compared to FIG. 4.

In the above-described embodiment, a capacitance value of the first capacitor C1 and a capacitance value of the second capacitor C2 may be determined according to the characteristics (for example, a transistor size, a channel length, and a channel width) of the first transistor Mpass, the second transistor Mcon, the third transistor Mcas, and the fourth transistor Mbuf.

In one embodiment, a capacitance value of the second capacitor C2 may be set to be greater than a capacitance value of the first capacitor C1 to satisfy a power supply rejection ratio (PSRR). The PSRR is an indicator that indicates how much noise is attenuated at an output when noise is applied to a power supply.

Referring again to FIGS. 1 and 2, an output capacitor 170 (Cout) is connected between the first node ND1 and the ground GND, and the load 190 is connected in parallel with the output capacitor 170 (Cout). In this case, the load 190 may be a component to which the output voltage VOUT output from the LDO voltage regulator 100 is supplied and may be expressed as a load resistance Rload as shown in FIG. 2. That is, the load resistor Rload is connected between the first node ND1 and the ground GND.

The reference voltage generation circuit 180 generates the reference voltage Vref and inputs the reference voltage Vref to the amplifier 120. In one embodiment, the reference voltage generation circuit 180 may be implemented as a band gap reference circuit (BGR) that may generate the reference voltage Vref and supply the reference voltage Vref to the amplifier 120. The BGR may generate a temperature-independent reference voltage Vref and input the temperature-independent reference voltage Vref to the amplifier 120.

Although the LDO voltage regulator 100 is illustrated in FIGS. 1 and 2, as including the reference voltage generation circuit 180, this is merely an example, and the reference voltage generation circuit 180 may be implemented as a separate device separate from the LDO voltage regulator 100.

The output voltage VOUT of the low dropout voltage regulator 100 according to the present disclosure having the configuration described above is voltage-dropped by the FVF circuit 110 and is output, the feedback voltage Vfb generated through voltage dividing of the output voltage VOUT by the first resistor R1 and the second resistor R2 included in the voltage divider circuit 115 is fed back to the amplifier 120, and the amplifier 120 compares the reference voltage Vref and the feedback voltage Vfb and outputs a signal amplified by a difference therebetween to a gate of the second transistor Mcon. Thus, the second transistor Mcon is controlled to maintain the constant output voltage VOUT. The output capacitor 170 (Cout) maintains the constant output voltage VOUT.

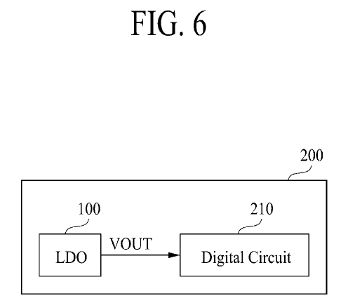

FIG. 6 is a block diagram of an electronic device embedded with the LDO voltage regulator shown in FIGS. 1 and 2. Referring to FIG. 6, an electronic device 200 may include the LDO voltage regulator 100 embedded therein and a digital circuit 210 that uses an output voltage VOUT generated by the LDO voltage regulator 100 as an operating voltage.

The electronic device 200 may be an integrated circuit (IC), a microcontroller unit (MCU), a central processing unit (CPU), a graphics processing unit (GPU), a neural processing unit (NPU), a tensor processing unit (TPU), or an application-specific integrated circuit (ASIC).

For example, when the current consumption of the digital circuit 210 of the MCU is several milliamperes, the stable operating voltage VOUT may be supplied to the digital circuit 210 using the LDO voltage regulator 100 according to the embodiment of the present disclosure, that is, the capacitor-less type LDO voltage regulator 100 including the FVF circuit 110.

As another example, the electronic device 200 may be a display device, the display device may include a display panel, and the display panel may be an in-cell display panel.

According to the present disclosure, by applying a FVF circuit to a capacitor-less type low dropout (LDO) voltage regulator, a sub-feedback loop can operate before a main feedback loop operates, thereby obtaining an effect of improving the transient response performance of an LDO voltage regulator.

In addition, according to the present disclosure, by performing Miller compensation by adding a first capacitor between a gate terminal of a pass transistor and a drain terminal of a control transistor, a first pole formed at the gate terminal of the pass transistor and a second pole formed at an output node can be separated from each other in a frequency band to improve loop stability, thereby increasing a gain margin and a phase margin.

In addition, according to the present disclosure, by adding a second capacitor between a gate terminal of a buffer transistor and a drain terminal of a control transistor, a zero can be inserted between a first pole and a second pole in a frequency band to further improve loop stability, thereby obtaining an effect of maximizing a gain margin and a phase margin.

What is claimed is:

1. A low dropout voltage regulator comprising:
a flipped voltage follower (FVF) circuit including a control transistor configured to regulate an output voltage at an output node and a pass transistor configured to supply a load current to the output node;
a cascode transistor connected to the control transistor to reduce output impedance of the FVF circuit;
an amplifier configured to amplify a difference between a feedback voltage generated based on the output voltage and a reference voltage, and output the amplified difference to the control transistor; and
a first capacitor configured to separate a first pole formed at a gate terminal of the pass transistor from a second pole formed at the output node in a frequency band.

2. The low dropout voltage regulator of claim 1, wherein the first capacitor is connected between the gate terminal of the pass transistor and a drain terminal of the control transistor.

3. The low dropout voltage regulator of claim 1, further comprising a buffer transistor connected to the cascode transistor and the pass transistor to further reduce the output impedance of the FVF circuit.

4. The low dropout voltage regulator of claim 3, further comprising a second capacitor connected between a gate terminal of the buffer transistor and a drain terminal of the control transistor and configured to insert a zero between the first pole and the second pole in the frequency band.

5. The low dropout voltage regulator of claim 4, wherein a capacitance value of the second capacitor is greater than a capacitance value of the first capacitor.

6. The low dropout voltage regulator of claim 3, wherein a gate terminal of the buffer transistor is connected to a drain terminal of the cascode transistor,
a source terminal of the buffer transistor is connected to the gate terminal of the pass transistor, and
a drain terminal of the buffer transistor is connected to a voltage supply line configured to supply an operating voltage to the pass transistor.

7. The low dropout voltage regulator of claim 3, further comprising a voltage divider circuit configured to divide the output voltage to generate the feedback voltage,
wherein the pass transistor, the control transistor, the cascode transistor, and the buffer transistor comprise a first feedback loop,
the voltage divider circuit, the amplifier, and the control transistor comprise a second feedback loop, and
the first feedback loop operates before the second feedback loop operates.

8. The low dropout voltage regulator of claim 1, further comprising a voltage divider circuit configured to divide the output voltage to generate the feedback voltage,
wherein the amplifier includes a first input terminal configured to receive the reference voltage, a second input terminal connected to the voltage divider circuit, and an output terminal connected to a gate of the control transistor.

9. The low dropout voltage regulator of claim 1, further comprising a band gap reference circuit configured to generate the reference voltage and input the reference voltage to the amplifier.

10. The low dropout voltage regulator of claim 1, wherein the first capacitor separates the first pole from the second pole in the frequency band by shifting a first frequency of the first pole to a frequency lower than the first frequency and shifting a second frequency of the second pole to a frequency higher than the second frequency.

11. A low dropout voltage regulator comprising:
a first transistor connected between a voltage supply line and an output node from which an output voltage is output;
a second transistor connected between the output node and a ground node;
a third transistor connected to a drain terminal of the second transistor;
an amplifier configured to amplify a difference between a feedback voltage generated based on the output voltage and a reference voltage and output the amplified difference to a gate terminal of the second transistor; and
a first capacitor connected to a gate terminal of the first transistor and a drain terminal of the second transistor.

12. The low dropout voltage regulator of claim 11, further comprising a fourth transistor connected to a drain terminal of the third transistor and the gate terminal of the first transistor.

13. The low dropout voltage regulator of claim 12, wherein the first capacitor separates a first pole formed at the gate terminal of the first transistor from a second pole formed at the output node in a frequency band through Miller compensation.

14. The low dropout voltage regulator of claim 13, wherein the first capacitor separates the first pole from the second pole in the frequency band by shifting a first frequency of the first pole to a frequency lower than the first frequency and shifting a second frequency of the second pole to a frequency higher than the second frequency.

15. The low dropout voltage regulator of claim 13, further comprising a second capacitor connected to a gate terminal of the fourth transistor and the drain terminal of the second transistor and configured to add a zero between the first pole and the second pole in the frequency band.

16. The low dropout voltage regulator of claim 15, wherein a capacitance value of the second capacitor is greater than a capacitance value of the first capacitor.

17. The low dropout voltage regulator of claim 12, further comprising a voltage divider circuit configured to divide the output voltage to generate the feedback voltage,
wherein the first transistor, the second transistor, the third transistor, and the fourth transistor comprise a first feedback loop, and
the voltage divider circuit, the amplifier, and the second transistor comprise a second feedback loop.

18. The low dropout voltage regulator of claim 17, wherein the first feedback loop operates before the second feedback loop operates.

19. The low dropout voltage regulator of claim 11, further comprising a voltage divider circuit configured to divide the output voltage to generate the feedback voltage,
wherein the amplifier includes a first input terminal configured to receive the reference voltage, a second input terminal connected to the voltage divider circuit, and an output terminal connected to a gate of the second transistor.

20. The low dropout voltage regulator of claim 11, further comprising a band gap reference circuit configured to generate the reference voltage and input the reference voltage to the amplifier.
